(19) United States
(12) Patent Application Publication
(10) Pub. No.: US 2017/0291563 A1
(43) Pub. Date: Oct. 12, 2017

(54) BUMPER PACKAGING ASSEMBLY AND METHOD OF USE

(71) Applicant: ARSN USA, INC., Laguna Hills, CA (US)

(72) Inventor: Sungbok KIM, Irvine, CA (US)

(73) Assignee: ARSN USA, INC., Laguna Hills, CA (US)

(21) Appl. No.: 15/095,487

(22) Filed: Apr. 11, 2016

Related U.S. Application Data
(63) Continuation-in-part of application No. 29/560,729, filed on Apr. 8, 2016.

(51) Int. Cl. B60R 19/44

(52) U.S. Cl. CPC B60R 19/44

(57) ABSTRACT

The disclosure herein relates to vehicle bumper packaging material and method of using. More specifically, the present disclosure relates to a vehicle bumper packaging assembly that is adjustable to fit multiple different bumper shapes and sizes, quick to assemble, and easy to store

### CROSS-REFERENCE TO RELATED APPLICATIONS

This application claims the benefit of U.S. application Ser. No. 29/560,729, filed on Apr. 8, 2016, and entitled “Vehicle Bumper Cover.” The entire contents of the earlier application are incorporated by reference herein.

### TECHNICAL FIELD

The disclosure herein relates to vehicle bumper packaging material and method of using. More specifically, the present disclosure relates to a vehicle bumper packaging assembly that is adjustable to fit multiple different bumper shapes and sizes, quick to assemble, and easy to store.

### BACKGROUND

Protection of vehicle bumpers for shipping or long term storage typically requires either specifically shaped packaging that matches the shape and size of the bumper or a large rectangular box. When using specifically shaped boxes, the packaging is constructed from a single piece of material that is then manually wrapped around the bumper. When using large rectangular boxes, excessive amounts of padding must be included to support the shape of the bumper. Preparing vehicle bumpers for shipping is a time consuming process. The disclosure herein is directed to improving this process.

### SUMMARY

The following simplified summary provides a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented below

The disclosure herein in generally directed to a bumper packaging assembly (herein referred to as “assembly”). The assembly includes a first planar sheet of material having a first end and a second end, and having a generally rectangular shape and a second planar sheet of material having a first end, a second end, a first edge and a second edge, and having a generally rectangular shape. In some embodiments, the second planar sheet is two or more planar sheets that are attached together to make the second planar sheet. In some embodiments, the assembly also include at least two couplers. In other embodiments, the assembly includes at least 4 couplers.

In one embodiment, the first or second planar sheets of material can be made from cardboard or plastic. In another embodiment, the material is cardboard. In another embodiment, the material is plastic.

In one embodiment, the size of the first planar sheet of material may be at least 1500 mm long. In another embodiment, the size of the first planar sheet is less than 4000 mm long. In another embodiment, the size of the first planar sheet is at least 500 mm wide. In another embodiment, the size of the first planar sheet is less than 2500 mm wide.

In one embodiment, the size of the second planar sheet is at least 2500 mm long. In another embodiment, the size of the second planar sheet less than 5000 mm long. In another embodiment, the size of the second planar sheet is at least 500 mm wide. In another embodiment, the size of the second planar sheet is less than 1500 mm long.

In one embodiment, the first and second ends of the first planar sheet can be attached using a slot and tab closing system. In another embodiment, the first and second ends of the first planar sheet can be attached using double sided tape. In another embodiment, the first and second ends of the first planar sheet can be attached using a hook and loop fastener system.

In one embodiment, the first planar sheet and/or the second planar sheet is pre-creased or scored to facilitate folding. In another embodiment, the second planar sheet is pre-cut, perforated, or scored to facilitate shortening. In another embodiment, the second planar sheet has a plurality of pre-cut or punch-out holes along both sides of the long edge.

The disclosure herein is also directed to a method of wrapping a vehicle bumper using the bumper packaging assembly described above. This can be accomplished by a single person. The first planar sheet is laid on the ground. The second planar sheet is laid perpendicularly on top of the first planar sheet forming a cross-like shape. In embodiments where the second planar sheet is made up of smaller pieces, the smaller pieces are attached together to form the second planar sheet. The vehicle bumper is placed on top of the second planar sheet such that the bumper is centered along the length and width of the second planar sheet. The ends of the second planar sheet are wrapped around the ends of the bumper and secured. In one embodiment, the ends are secured using a coupler device. In another embodiment, the ends are secured using double sided tape. In another embodiment, the ends are secured using hook and loop closures. The first planar sheet is then wrapped around the center of the bumper and the ends are secured. In general, the bumper is initially wrapped with the end of the bumper curving upwards. When the first planar sheet is being wrapped around the center of the bumper, it may be helpful to rotate the bumper, such that the bumper is on edge. In one embodiment, the ends of the first planar sheet can be attached using a slot and tab system. In another embodiment, the ends can be attached using a hook and loop fastener system. In another embodiment, the ends can be attached using double sided tape.

### BRIEF DESCRIPTION OF THE DRAWINGS

FIG. 1 is a top view of a non-limiting embodiment of the components of the bumper packaging assembly.

FIG. 2 is perspective view of a non-limiting embodiment of the components of the bumper packaging assembly.

FIG. 3 is perspective view of a non-limiting embodiment of the partially assembled components of the bumper packaging assembly.

FIG. 4 is a perspective view of a non-limiting embodiment of the partially assembled components of the bumper packaging assembly with a vehicle bumper.

FIG. 5 is perspective view of a non-limiting embodiment of the partially assembled components of the bumper packaging assembly with a vehicle bumper.

FIG. 6 is a perspective view of a non-limiting embodiment of the partially assembled components of the bumper packaging assembly with a vehicle bumper.

FIG. 7 is a perspective view of a non-limiting embodiment of the partially assembled components of the bumper packaging assembly with a vehicle bumper.

FIG. 8 is a perspective view of a non-limiting embodiment of the partially assembled components of the bumper packaging assembly with a vehicle bumper.

FIG. 9 is perspective view of a non-limiting embodiment of the partially assembled components of the bumper packaging assembly with a vehicle bumper and coupler.

FIG. 10 is a perspective view of a non-limiting embodiment of the coupler attachment.

FIG. 11 is perspective view a non-limiting embodiment of the couple attachment.

FIG. 12 is a perspective view of a non-limiting embodiment of the partially assembled components of the bumper packaging assembly with a vehicle bumper.

FIG. 13 is a perspective view of a non-limiting embodiment of the partially assembled components of the bumper packaging assembly with a vehicle bumper.

FIG. 14 is a perspective view of a non-limiting embodiment of the closing mechanism.

FIG. 15 is a perspective view of a non-limiting embodiment of the closing mechanism.

FIG. 16 is a perspective view of a non-limiting embodiment of the front of an assembled bumper packaging.

FIG. 17 is a perspective view of a non-limiting embodiment of the back of an assembled bumper packaging.

### DETAILED DESCRIPTION

Vehicle bumpers are large, bulky, and awkward objects. Packaging them for shipping or long term storage is a time consuming process. Although many automotive manufacturing process have been automated, packing bumpers is still done manually. The disclosure herein is directed to an improved bumper packing method using a new bumper packaging assembly. The improvements include: (1) decreasing the time needed to manually package a vehicle bumper packaging; (2) smaller pieces that are easier to use and store; (3) increased protection around the center of the bumper; and (4) adaptable to work with a variety of different size bumpers with minimal adjustments.

When the terms “one,” “a,” or “an” are used in this disclosure, they mean “at least one” or “one or more,” unless otherwise indicated.

The terms “invention” or “present invention” as used herein are intended to be non-limiting and are not intended to refer to any single embodiment of the particular invention but encompasses all possible embodiments as described in the specification and the claims.

The term “assembly” as used herein refers to a group of items that are used together.

### Bumper Packaging Assembly

The bumper packaging assembly (herein referred to as “assembly”) disclosed herein includes at least two planer sheets of material that wrap around the length and width of a vehicle bumper. In one embodiment, the planer sheet of material that wraps around the length of the bumper (herein referred to as “horizontal sheet”) may be one piece. In another embodiment, the horizontal sheet may be two or more pieces that can be connected together before use. In one embodiment, the planar sheet of material that wraps around the width of the bumper (herein referred to as “vertical sheet”) may be one piece. In another embodiment, the vertical sheet may be two or more pieces that can be connected together before use.

In general, the horizontal sheet is roughly rectangular in shape. In embodiments using two or more pieces, each piece may be roughly square or rectangular in shape. Additional shapes that accomplish the same function are also contemplated. In general, the overall length of the horizontal piece is roughly one and a half to three times the length of the vehicle bumper. In one embodiment, the horizontal sheet is at least 2000 mm long. In another embodiment, the horizontal sheet is at least 2250 mm long. In another embodiment, the horizontal sheet is at least 2500 mm long. In another embodiment, the horizontal sheet is at least 2750 mm long. In another embodiment, the horizontal sheet is at least 3000 mm long. In another embodiment, the horizontal sheet is at least 3250 mm long. In another embodiment, the horizontal sheet is at least 3500 mm long. In another embodiment, the horizontal sheet is at least 3750 mm long. In another embodiment, the horizontal sheet is at least 4000 mm long. In another embodiment, the horizontal sheet is at least 4250 mm long. In another embodiment, the horizontal sheet is at least 4500 mm long. In another embodiment, the horizontal sheet is at least 4750 mm long. In another embodiment, the horizontal sheet is at least 5000 mm long. In another embodiment, the horizontal sheet is at least 5250 mm long. In another embodiment, the horizontal sheet is at least 5500 mm long. In another embodiment, the horizontal sheet is at least 5750 mm long. In another embodiment, the horizontal sheet is at least 6000 mm long. In one embodiment, the horizontal sheet is at least 300 mm wide. In another embodiment, the horizontal sheet is at least 400 mm wide. In another embodiment, the horizontal sheet is at least 500 mm wide. In another embodiment, the horizontal sheet is at least 600 mm wide. In another embodiment, the horizontal sheet is at least 700 mm wide. In another embodiment, the horizontal sheet is at least 800 mm wide. In another embodiment, the horizontal sheet is at least 900 mm wide. In another embodiment, the horizontal sheet is at least 1000 mm wide. In embodiments using two or more separate pieces to make up the horizontal sheet, the overall length and width of the pieces when connected are the same as listed above.

In general, the vertical sheet is roughly rectangular in shape. In embodiments using two or more pieces, each piece may be roughly square or rectangular in shape. Additional shapes that accomplish the same function are also contemplated. In general, the overall length of the vertical piece is roughly two and a half to three and a half times the width of the vehicle bumper. In one embodiment, the vertical sheet is at least 1500 millimeters (mm) long. In another embodiment, the vertical sheet is at least 1700 mm long. In another embodiment, the vertical sheet is at least 1800 mm long. In another embodiment, the vertical sheet is at least 1900 mm long. In another embodiment, the vertical sheet is at least 2000 mm long. In another embodiment, the vertical sheet is at least 2200 mm long. In another embodiment, the vertical sheet is at least 2400 mm long. In one embodiment, the vertical sheet is at least 500 mm wide. In another embodiment, the vertical sheet is at least 600 mm wide. In another embodiment, the vertical sheet is at least 700 mm wide. In another embodiment, the vertical sheet is at least 800 mm wide. In another embodiment, the vertical sheet is at least 900 mm wide. In another embodiment, the vertical sheet is at least 1000 mm wide. In another embodiment, the vertical sheet is at least 1100 mm wide. In another embodiment, the vertical sheet is at least 1200 mm wide. In embodiments using two or more separate pieces to make up the vertical sheet, the overall length and width of the pieces when connected are the same as listed above.

The thickness of both the horizontal sheet and vertical sheet may be the same or different. In one embodiment, the thickness is at least 5 mm. In another embodiment, the thickness is at least 10 mm. In another embodiment, the thickness is at least 15 mm. In another embodiment, the thickness is at least 20 mm. In another embodiment, the thickness is at least 25 mm. In another embodiment, the thickness is at least 30 mm. In another embodiment, the thickness is at least 35 mm. In another embodiment, the thickness is at least 40 mm. In another embodiment, the thickness is at least 45 mm. In another embodiment, the thickness is at least 50 mm.

The horizontal sheet and vertical sheet may be made from a variety of different materials that can provide protection during shipping and storing. Additionally, the material should be rigid enough to withstand shipping and also flexible enough to wrap around the edges of the bumper. Non-limiting examples of materials include cardboard and plastic. In some embodiments, the material may also have a coating to further protect against the elements. The coating, the coating may be on one side or both sides of the material. Non-limiting examples of coatings include epoxy, wax, flocking, etc. In other embodiments, the material may be lined to protect against scratching. In Non-limiting examples of lining include felt, foam, etc. In one embodiment, the material is the same for the horizontal sheet and the vertical sheet. In another embodiment, the material may be different for the horizontal sheet and the vertical sheet. In another embodiment, the material may have the same coating for the horizontal sheet and the vertical sheet. In another embodiment, the material may have different coatings for the horizontal sheet and the vertical sheet. In another embodiment, the material may only be coated on one side for either the horizontal sheet or the vertical sheet.

Due to the differing sizes of vehicle bumpers, another embodiment contemplated to have multiple pieces that can be joined together to make the final horizontal sheet and vertical sheets. For example, horizontal pieces roughly 500 mm in length could be combined to make a horizontal sheet that is 2000 mm, 2500 mm, 3000 mm, 3500 mm, etc., in length.

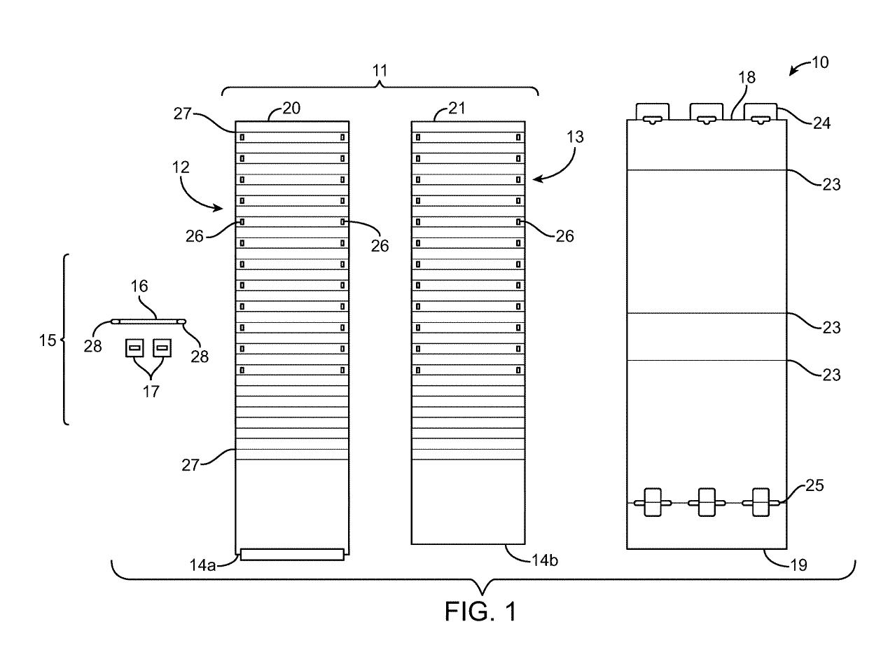

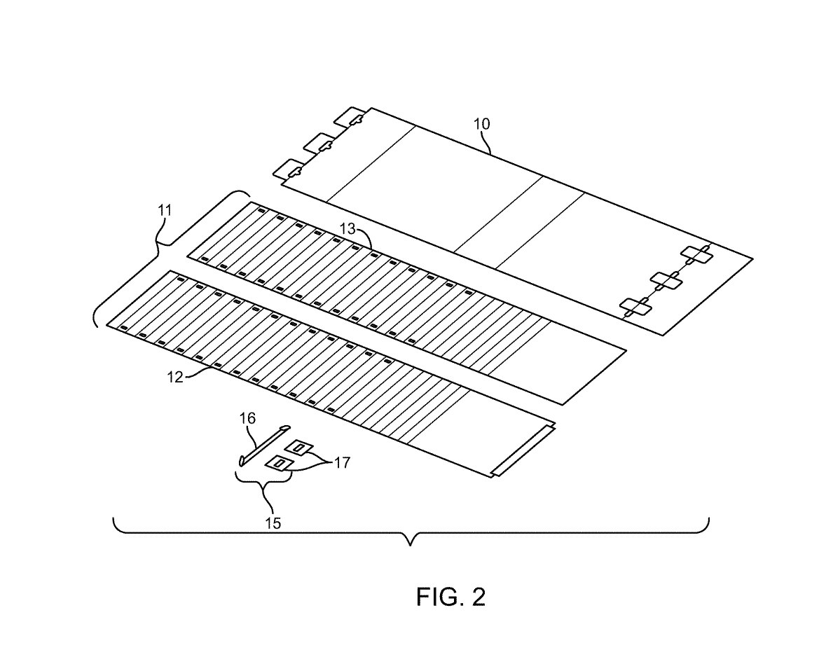

FIGS. 1, 2, and 3 show one embodiment of the main components of the assembly. The components include vertical sheet 10, horizontal sheet 11, and optionally coupler 15. In this embodiment, length sheet 11 is made up of two pieces, 12 and 13, which are attached together at junction 14. Pieces 12 and 13 may be joined using a variety of methods; non-limiting methods include tape, glue, hook and loop (e.g., Velcro®) fasteners, staples, slot joint, etc. The coupler 15 includes joiner piece 16 and two end pieces 17.

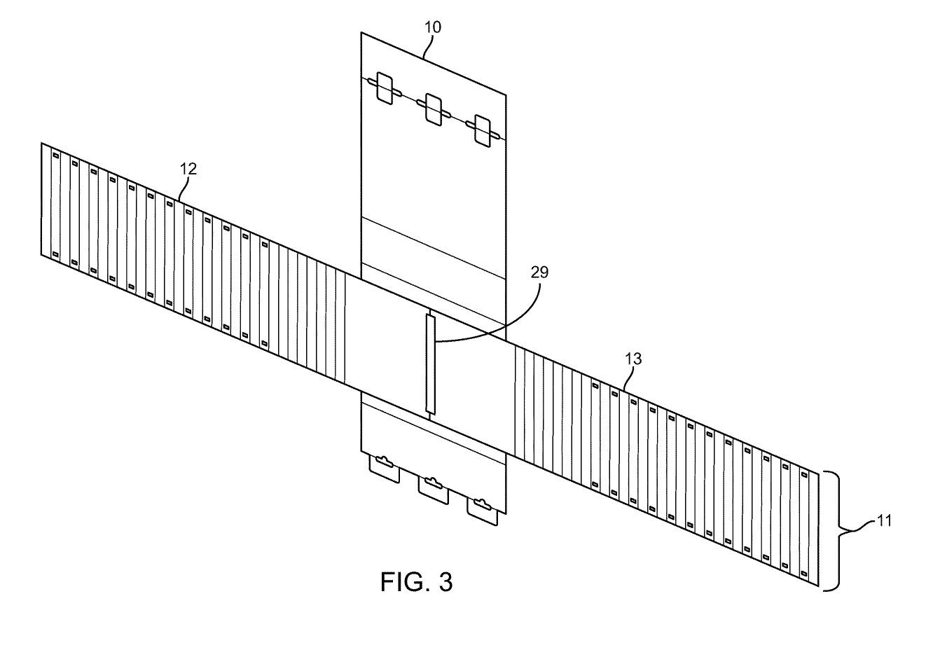

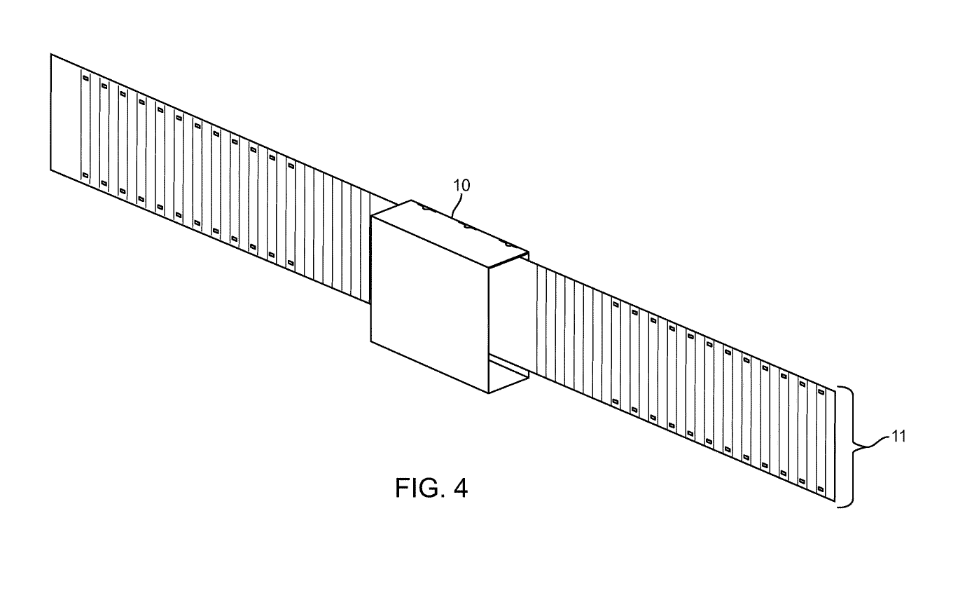

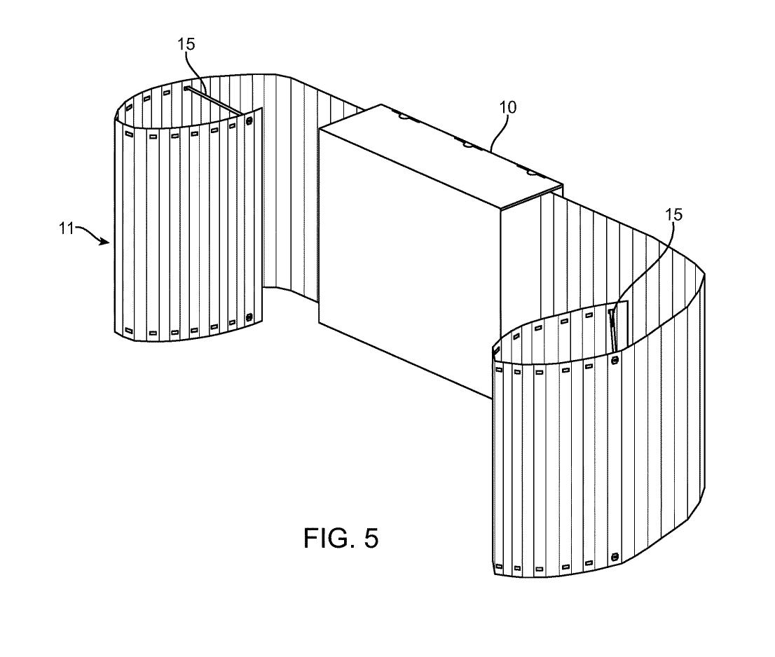

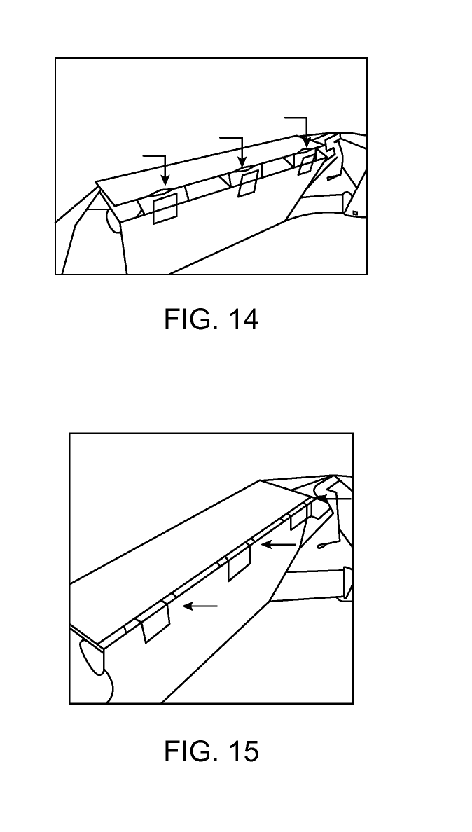

Vertical sheet 10 has a first end 18 and a second end 19. Vertical sheet 10 is designed to fold up into a roughly rectangular shaped cuboid or box with opposing open sides by joining first end 18 and second end 19 (see FIGS. 4 and 5). Vertical sheet 10 may be pre-creased or pre-scored (e.g. 23)to make folding easier. In the embodiment shown in FIGS. 1, 2, and 3, vertical sheet ends 18 and 19 are pre-cut to allow for easy and secure joining using a tab 24 and slot 25 system. In one embodiment, the tab and slot system may be a single tab and slot system. In another embodiment, the tab and slot system may be a double tab and slot system as shown in FIGS. 1, 2, 3, 13, 14, and 15. In another embodiment, the number of tab and slot closures may vary depending on the overall size of the vertical sheet. In another embodiment, the tab and slot closures may be evenly spaces. In another embodiment, the tab and slot closures may be unevenly spaced. In another embodiment, vertical sheet ends 18 and 19 may be secured using glue. In another embodiment, vertical sheet ends 18 and 19 may be secured using tape. In another embodiment, vertical sheet ends 18 and 19 may be secured using a hook and loop fastener.

Horizontal sheet 11 has a first end 20 and a second end 21. In this embodiment horizontal sheet 11 is made up of at least two pieces 12 and 13. Pieces 12 and 13 each have a first end and a second end. For piece 12, first end is 14a and second end corresponds to first end 20 of horizontal sheet 11. For piece 13, first end is 14b and second end corresponds to second end 21 or horizontal sheet 11. First ends 14a and 14b when attached together form junction 14. First ends 14a and 14b may be attached using a variety of methods. Non-limiting examples include tape 29, glue, hook and loop fastener, etc. Horizontal sheet 11 is designed to wrap around the outer edges of the bumper length and attach to itself using at least one coupler. In the embodiment shown in FIGS. 1, 2, 3, 4, and 5, horizontal sheet 11 has at least 8 pre-cut or punch-out holes 26 (herein referred to as “holes”) along opposing edges of the length of the length sheet. The holes are used by the coupler 15 to keep folded over ends 20 and 21 in place. In the embodiment shown in FIGS. 1, 2, 3, 4, and 5, a plurality of holes run along the length side the length sheet 11. In this embodiment, the holes run from the first end 20 or second end 21 to about the center of piece 12 or 13. In another embodiment, the holes may run the entire length of length sheet 11. In another embodiment, the holes may run from the first end 20 or second end 21 to about a first quarter of piece 12 or 13. In another embodiment, the holes may run from the first end 20 or second end 21 to about the first three-quarters of piece 12 or 13. In this embodiment, the holes are evenly spaced. In other embodiments, the holes may be unevenly spaced. Horizontal sheet 11 may be pre-creased or pre-scored 27 to allow for easy wrapping. Horizontal sheet 11 may also be pre-cut, perforated, or pre-scored 27 to allow for shortening, if needed.

Coupler 15 has a joiner piece 16 and two end pieces 17. The parts of coupler 15 can be made from a variety of different plastic or polymer materials. Non-limiting examples include polyvinyl chloride (PVC), polypropylene (PP), polystyrene (PS), polyethylene terephthalate (PET), polyethylene (PE), polyurethane (PU), nylon, derivatives of the foregoing, etc. The length of the coupler may vary depending on the thickness of the bumper. In general the over length of the coupler is similar or slightly larger than the width of the vehicle bumper. In one embodiment, the couple may be 5% longer than the width of the vehicle bumper. In another embodiment, the coupler may be 10% longer than the width of the vehicle bumper. In another embodiment, the coupler may be 15% longer than the width of the vehicle bumper. In another embodiment, the coupler may be 20% longer than the width of the vehicle bumper. In one embodiment, the length of the couple is at least 75 mm. In another embodiment, the length of the coupler is at least 100 mm. In another embodiment, the length of the coupler is at least 125 mm. In another embodiment, the length of the coupler is at least 150 mm. In another embodiment, the length of the couple is at least 175 mm. In another embodiment, the length of the coupler is at least 200 mm. In another embodiment, the length of the coupler is at least 225 mm. In another embodiment, the length of the coupler is at least 250 mm. In another embodiment, the length of the coupler is at least 275 mm. In another embodiment, the length of the coupler is at least 300 mm.

Joiner piece 16 is generally stick-like or strip-like in shape with a flange 28 on each end. In one embodiment, the flange 28 encircles or encompasses each end of joiner piece 16. In another embodiment, the flange 28 is on one side of each end of joiner piece 16. Generally, the flange 28 can be compressed to be pushed through end piece 17. Once through end piece 17, the flange 28 catches on end piece 17 to keep joiner piece 16 attached to end piece 17.

End piece 17 is roughly annular or ring in shape. However, the ring may be based on a circle, square, or other polygonal shape. In the embodiment shown in FIG. 1, end piece 17 is roughly a square-shaped ring. The inner opening of the ring should be sized such that the flanged end of joiner piece 16 can fit though when the flange is compressed but cannot pass back through when the flange is in an uncompressed state. In one embodiment, the shortest diameter of end piece 17 is at least 20 mm. In another embodiment, the shortest outer diameter of end piece 17 is at least 25 mm. In another embodiment, the shortest diameter of end piece 17 is at least 30 mm. In another embodiment, the shortest diameter of end piece 17 is at least 45 mm. In another embodiment, the shortest diameter of end piece 17 is at least 35 mm. In another embodiment, the shortest diameter of end piece 17 is at least 40 mm. In another embodiment, the shortest diameter of end piece 17 is at least 45 mm. In another embodiment, the shortest diameter of end piece 17 is at least 50 mm. In another embodiment, the shortest diameter of end piece 17 is at least 60 mm. In another embodiment, the shortest diameter of end piece 17 is at least 70 mm. In another embodiment, the shortest diameter of end piece 17 is at least 80 mm. In another embodiment, the shortest diameter of end piece 17 is at least 90 mm. In another embodiment, the shortest diameter of end piece 17 is at least 100 mm.

### Packaging a Bumper

The above described bumper packaging assembly is easy to put together and wrap around a bumper. Using multiple smaller pieces is much simpler and easier for a single person to handle as compared to having one large piece. Additionally, the bumper packaging assembly provides extra protection around the center of the bumper via a double layer wrap. Further, the bumper packaging assembly can easily be adapted to fit a variety of different sized bumpers with minimal adjustments. For example, the same bumper packaging assembly could be used to cover a vehicle bumper ranging from roughly 1600 mm up to 2600 mm in length. Having pre-scored, perforated, or pre-cut lines along the width of the horizontal sheet would allow a user to easily trim the horizontal sheet to fit the bumper. Alternatively, the extra length can be wrapped around the bumper to provide additional protection. Also, since the assembly pieces are generally rectangular in shape, they can easily be stored in either a flat or on edge position.

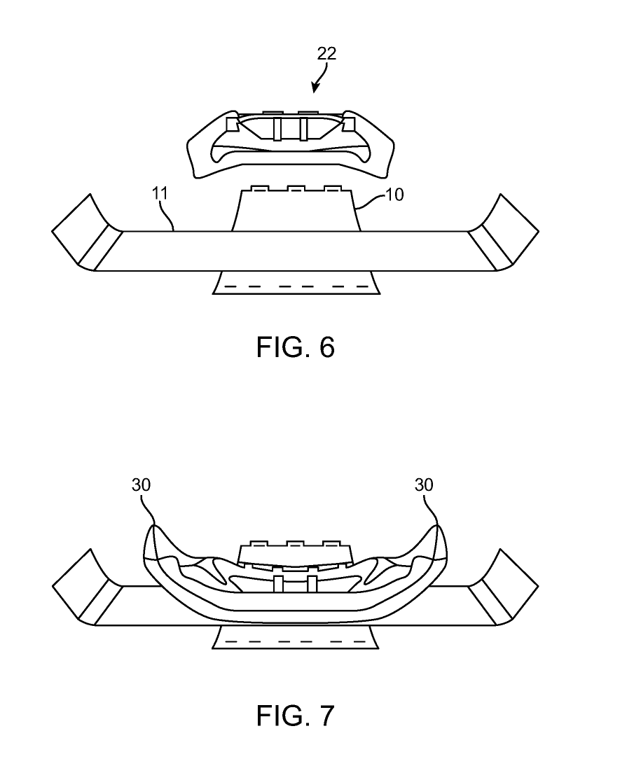

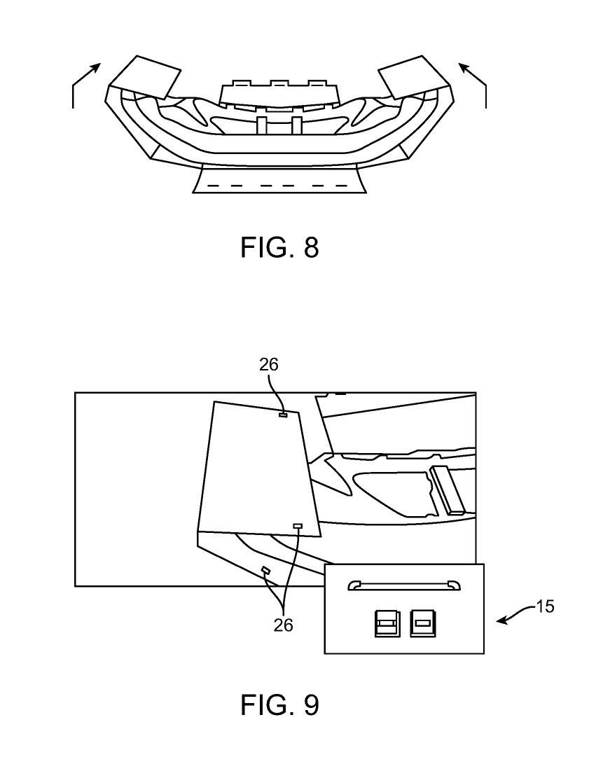

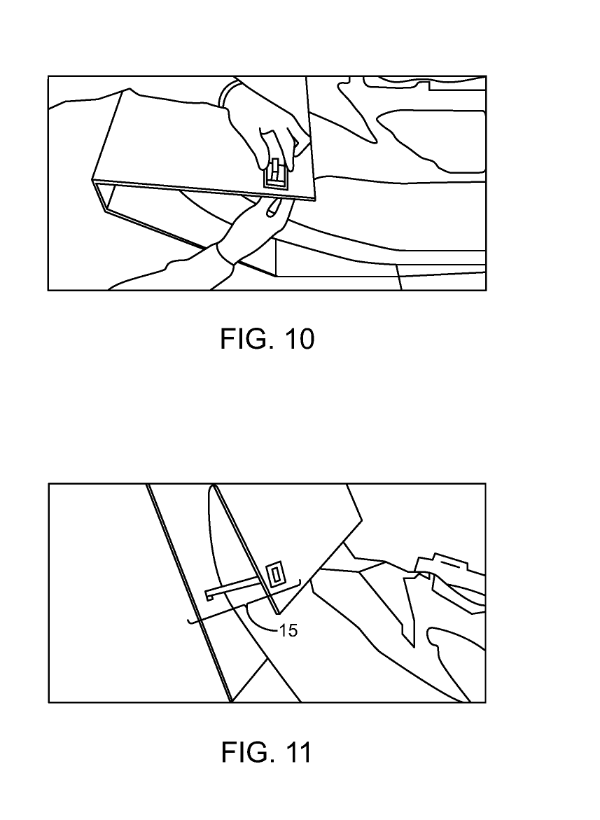

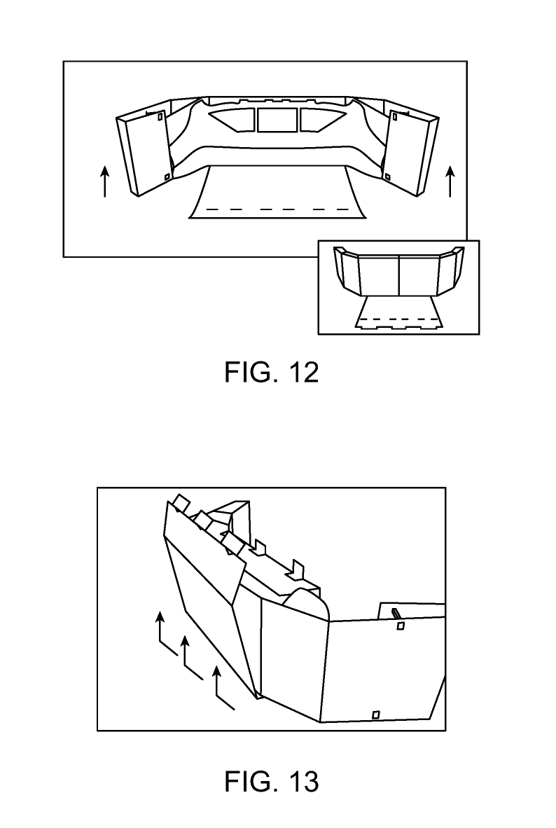

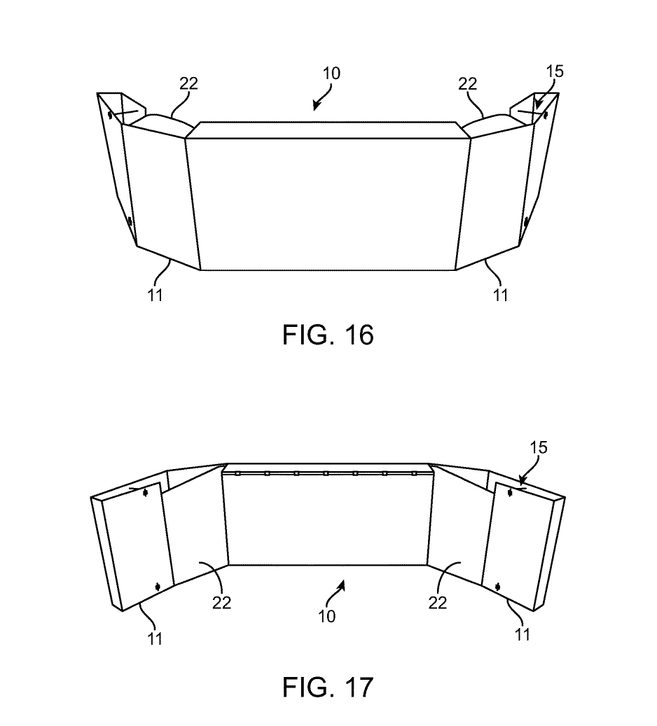

FIGS. 6 through 17 illustrate one non-limiting embodiment of wrapping a vehicle bumper using the bumper packaging assembly described above. As shown in FIGS. 3 and 6, horizontal sheet 11 is place on top of vertical sheet 10, forming a cross-like shape. In FIG. 7, bumper 22 is placed on top of horizontal sheet 11 such that the long edge of the bumper is centered along the long edge of horizontal sheet 11. In one embodiment, the bumper is placed such that the end pieces 30+ are pointing up. In FIGS. 8, 9, 10, and 11, end pieces 20 and 21 are folded over the ends of the bumper and secured using multiple couplers 15. In FIGS. 12, 13, 14, and 15, vertical sheet 10 is wrapped around the center of the bumper and end pieces 18 and 19 are joined. When wrapping the vertical sheet, it may be helpful to stand the bumper on its edge. FIGS. 16 and 17 show the wrapped bumper. The wrapped bumper is stable enough to stand on edge.

### EXAMPLES

### Example 1

### Assembly Time

In this example, a person was timed covering a bumper using the bumper packaging assembly described herein. In general, covering a bumper takes over two minutes. Using the bumper packaging assembly described herein, one person was able to cover a bumper in less than one minute.

The examples set forth above are provided to give those of ordinary skill in the art a complete disclosure and description of how to make and use embodiments of the compositions, and are not intended to limit the scope of what the inventors regard as their invention. Modifications of the above-described modes (for carrying out the invention that are obvious to persons of skill in the art) are intended to be within the scope of the following claims. All publications, patents and patent applications cited in this specification are incorporated herein by reference as if each such publication, patent or patent application were specifically and individually indicated to be incorporated herein by reference.

What is claimed is:

1. A bumper packaging assembly comprising:
a first planar sheet of material having a first end and a second end, and having a generally rectangular shape;
a second planar sheet of material having a first end, a second end, a first edge and a second edge, and having a generally rectangular shape; and
at least two couplers.

2. The bumper packaging assembly of claim 1, wherein the material is selected from the group consisting of cardboard and plastic.

3. The bumper packaging assembly of claim 2, wherein the material is cardboard.

4. The bumper packaging assembly of claim 1, wherein the first planar sheet is at least 1500 mm long.

5. The bumper packaging assembly of claim 1, wherein the first planar sheet is less than 4000 mm long.

6. The bumper packaging assembly of claim 1, wherein the first planar sheet is at least 500 mm wide.

7. The bumper packaging assembly of claim 1, wherein the first planar sheet is less than 2500 mm wide.

8. The bumper packaging assembly of claim 1, further comprising a slot and tab closing system on the first end and second end of the first planar sheet.

9. The bumper packaging assembly of claim 1, wherein the second planar sheet is at least 2500 mm long.

10. The bumper packaging assembly of claim 1, wherein the second planar sheet less than 5000 mm long.

11. The bumper packaging assembly of claim 1, wherein the second planar sheet is at least 500 mm wide.

12. The bumper packaging assembly of claim 1, wherein the second planar sheet is less than 1500 mm long.

13. The bumper packaging assembly of claim 1, further comprising a plurality of pre-cut or punch-out holes along the first edge and the second edge of the second planar sheet.

14. The bumper packaging assembly of claim 1, wherein the second planar sheet further comprises a fourth planar sheet and a fifth planar sheet, wherein the fourth planar sheet and the fifth planar sheet are each about one half the length of the second planar sheet; wherein the fourth planar sheet and the fifth planar sheet are each the same width as the second planar sheet; and wherein the fourth planar sheet and the fifth planar sheet are attached to make the second planar sheet.

15. The bumper packaging assembly of claim 1, further comprising at least four couplers.

16. A method for wrapping a vehicle bumper comprising the steps of:
laying a first planar sheet on the ground, wherein the first planar sheet has a first end and a second end;
laying a second planar sheet on top of and perpendicular to the first planar sheet, wherein the second planar sheet has a first end, a second end, a first edge, and a second edge, wherein the first edge and the second edge have a plurality of pre-cut, perforated, or punch out holes;
placing a vehicle bumper in the center of the second planar sheet, wherein the vehicle bumper has a first end, a second end, a top end, and a bottom end;
wrapping the first end of the second planar sheet around the first end of the bumper and attaching the first edge to the first edge of the second planar sheet and attaching the second edge to the second edge of the second planar sheet;
wrapping the second end of the second planar sheet around the second end of the bumper and attaching the first edge to the first edge of the second planar sheet and attaching the second edge to the second edge of the second planar sheet;
wrapping the first planar sheet around the top end and the bottom end of the bumper and attaching the first end and second end of the first planar sheet together.

17. The method of claim 16, further comprising standing the bumper on edge during the wrapping of the first planar sheet.

18. The method of claim 16, wherein the second planar sheet further comprises a third planar sheet and a fourth planar sheet, wherein the third planar sheet and the fourth planar sheet are attached to form the second planar sheet.

19. The method of claim 16, wherein the attaching of the first edge to the first edge of the second planar sheet and the attaching of the second edge to the second edge of the second planar sheet occurs through the use of a coupler.

20. The method of claim 16, wherein the first end and the second end of the first planar sheet are attached using a slot and tab system.
